(19) United States
(12) Patent Application Publication
(10) Pub. No.: US 2022/0004560 A1
(43) Pub. Date: Jan. 6, 2022

(54) DATA MODEL MATCHING METHOD AND DEVICE

(71) Applicant: Kuyun (Shanghai) Information Technology Co., Ltd., Shanghai (JP)

(72) Inventors: Yifan ZHANG, Shanghai (CN); Yifei WU, Shanghai (CN); Yang LI, Shanghai (CN); Qing HAN, Shanghai (CN)

(21) Appl. No.: 17/051,011

(22) PCT Filed: Mar. 4, 2020
(86) PCT No.: PCT/CN2020/077706

§ 371 Date: Oct. 27, 2020

(30) Foreign Application Priority Data
Mar. 20, 2019 (CN) 201910213877.1

(51) Int. Cl. G06F 16/25; G06F 16/2455; G06F 16/28

(52) U.S. Cl. CPC G06F 16/254; G06F 16/288; G06F 16/2455

(57) ABSTRACT

The present application discloses a data model matching method and device. The method includes: determining at least two target data sets required to be queried by a query instruction and an ordered association between the target data sets; decomposing, on the basis of the ordered association between the target data sets, the at least two target data sets to obtain at least two data packets, wherein each of the data packets includes at least one target data set; for each of the data packets, matching, in a database, a first OLAP model corresponding to the data packet, on the basis of the target data set included in the data packet and the ordered association between the target data sets; and outputting the first OLAP model corresponding to each of the data packets. According to the present application, the technical problems of large demand quantity of OLAP models included in an OLAP query system and a low utilization rate of the OLAP models in the related art can be solved.

### CROSS-REFERENCE TO RELATED APPLICATIONS

The present application claims priority of Chinese Patent Application entitled “Data Model Matching Method and Device” filed to the Patent Office of China on Mar. 20, 2019, with the Application No. 2019102138771, the entire contents of which are hereby incorporated by reference.

### FIELD

The present application relates to a technical field of data model matching, and more particularly, to a data model matching method and device.

### BACKGROUND

In the present datamation era, how to analyze massive and complex data by means of Online Analytical Processing (OLAP) to assist business decision-making is an important topic in the field of business intelligence and data analysis; and a data model is the basis of OLAP analysis. The architecture bottom layer of the OLAP analysis is a data warehouse, which includes a series of data tables; according to service analysis demands, modeling personnel design a data model based on the tables for analysts to use; and finally, the analysis operation of an analyst can be converted into a series of structured query language (SQL) queries on the data tables. The data model endows the data tables with service meaning and decouples the relationship between the data bottom layer and the service demand, and how to effectively and associatively query the model and utilize the OLAP analysis to serve the service to the maximum extent is a very important part.

Due to the fact that the selection and matching logic of the OLAP model in a query engine is relatively fixed, the entire process has strict requirements on a target model and cannot adapt to an equivalent or similar model. Therefore, the number of OLAP models in the system will increase along with continuous increase of queries, which brings difficulties and challenges to storage, management, operation and maintenance of the whole system.

As for the technical problems of large demand quantity of OLAP models included in an OLAP query system and a low utilization rate of the OLAP models in the related art, no effective solutions have yet been proposed.

### SUMMARY

A main objective of the present application is to provide a data model matching method and device, to solve the problems of large demand quantity of OLAP models included in an OLAP query system and a low utilization rate of the OLAP models in the related art.

For achieving the above objective, in a first aspect, the present application provides a data model matching method, which is applied to the OLAP query system, and the method includes:

Determining at least two target data sets required to be queried by a query instruction and an ordered association between the target data sets; Decomposing, on the basis of the ordered association between the target data sets, the at least two target data sets to obtain at least two data packets, wherein each of the data packets includes at least one target data set;

Matching, in a database, a first OLAP model corresponding to the data packet, on the basis of the target data sets included in the data packet and the ordered association between the target data sets, for each of the data packets; and

Outputting the first OLAP model corresponding to each of the data packets.

Optionally, after determining the at least two target data sets required to be queried by the query instruction and the ordered association between the target data sets, the method further includes:

Determining whether a second OLAP model corresponding to the at least two target data sets required to be queried by the query instruction and the ordered association between the target data sets exists in the database; and

Executing, when no second OLAP model corresponding to the at least two target data sets required to be queried by the query instruction and the ordered association between the target data sets exists in the database, the step of decomposing, on the basis of the ordered association between the target data sets, the at least two target data sets.

Optionally, the method further includes:

Outputting the second OLAP model, when the second OLAP model corresponding to the at least two target data sets required to be queried by the query instruction and the ordered association between the target data sets exists in the database.

Optionally, the method further includes:

Taking, when only one target data set is included in the data packet, the only target data set included in the data packet as the first OLAP model corresponding to the data packet.

Optionally, before outputting first OLAP model corresponding to each of the data packets, the method further includes:

Determining whether a data packet which does not match a corresponding first OLAP model exists; and

Re-executing, when the data packet which does not match the corresponding first OLAP model exists, the step of decomposing, on the basis of the ordered association between the target data sets, the at least two target data sets to obtain a data packet different from that in the previous decomposition.

In a second aspect, the present application further provides a data model matching device, which is applied to the OLAP query system, and the device includes:

A first determination module, configured to determine at least two target data sets required to be queried by a query instruction and an ordered association between the target data sets;

A decomposition module, configured to decompose, on the basis of the ordered association between the target data sets, the at least two target data sets to obtain at least two data packets, wherein each of the data packets includes at least one target data set;

A first matching module, configured to match, in a database, a first OLAP model corresponding to the data packet, on the basis of the target data set included in the data packet and the ordered association between the target data sets, for each of the data packets; and

A first output module, configured to output the first OLAP model corresponding to each of the data packets.

Optionally, the device further includes a second determination module,

wherein the second determination module is configured to determine whether a second OLAP model corresponding to the at least two target data sets required to be queried by the query instruction and the ordered association between the target data sets exists in the database; and

A decomposition module is configured to execute, when no second OLAP model corresponding to the at least two target data sets required to be queried by the query instruction and the ordered association between the target data sets exists in the database, the step of decomposing, on the basis of the ordered association between the target data sets, the at least two target data sets.

Optionally, the device further includes:

A setting module, configured to take, when only one target data set is included in the data packet, the only target data set included in the data packet as the first OLAP model corresponding to the data packet.

In a third aspect, the present application further provides a computer device, which includes:

One or more processors; and

A memory, configured to store one or more computer programs;

The one or more computer programs, when executed by the one or more processors, cause the one or more processors to implement the data model matching method mentioned above.

In a fourth aspect, the present application further provides a computer-readable storage medium, having computer codes stored thereon, and the computer codes, when executed, cause the data model matching method mentioned above to be performed.

According to the data model matching method provided by the present application, the at least two target data sets required to be queried by the query instruction and the ordered association between the target data sets are determined; on the basis of the ordered association between the target data sets, the at least two target data sets are decomposed to obtain at least two data packets, wherein each of the data packets includes at least one target data set; for each of the data packets, the first OLAP model corresponding to the data packet is matched in a database, on the basis of the target data set included in the data packet and the ordered association between the target data sets; and the first OLAP model corresponding to each of the data packets is output. According to the above-mentioned method, the at least two target data sets required to be queried can be subjected to ordered association decomposition for the query instruction, OLAP model matching is performed on each of the data packets obtained by decomposition, and then a plurality of associated OLAP models corresponding to the query instruction are output, so that the success rate of OLAP model matching for the query instruction can be greatly improved, the support degree of OLAP model query matching can be greatly improved, and then the analysis acceleration advantage brought by pre-calculation by means of the OLAP models is reserved for execution of the query instruction; moreover, by means of the above-mentioned method, the application range of the OLAP data models is enlarged simultaneously, the demand quantity of OLAP models is reduced, the utilization rate of the OLAP models is improved, and the existing OLAP models are reused to the maximum extent; and therefore, the technical problems of large demand quantity of OLAP models included in the OLAP query system and a low utilization rate of the OLAP models in the related art are solved.

### BRIEF DESCRIPTION OF THE DRAWINGS

The accompanying drawings, which form a part of the present application, serve to provide a further understanding of the present application, such that other features, objectives, and advantages of the present application become more apparent. The accompanying drawings of illustrative embodiments of the present application and the description of the drawings serve to explain the present application and are not construed as unduly limiting the present application. In the drawings:

FIG. 1 is a schematic flowchart of a data model matching method provided in an embodiment of the present application;

FIG. 2 is a schematic diagram of an ordered association between target data sets, provided in an embodiment of the present application;

FIG. 3 is a schematic flowchart of another data model matching method provided in an embodiment of the present application;

FIG. 4 is a schematic diagram of optimal OLAP model provided in an embodiment of the present application;

FIG. 5 is a schematic diagram of suboptimal OLAP model decomposition provided in an embodiment of the present application;

FIG. 6 is a schematic structural diagram of a data model matching method provided in an embodiment of the present application;

FIG. 7 is a schematic structural diagram of another data model matching device provided in an embodiment of the present application; and

FIG. 8 is a schematic structural diagram of another data model matching device provided in an embodiment of the present application.

### DETAILED DESCRIPTION OF THE EMBODIMENTS

In order to enable those skilled in the art to better understand the solutions of the present application, the technical solutions of embodiments of the present application will be described below clearly and comprehensively in conjunction with accompanying drawings of the embodiments of the present application. Apparently, the embodiments described are merely some of rather than all of the embodiments of the present application. Based on the embodiments of the present application, all other embodiments obtained by those of ordinary skill in the art without inventive efforts should fall within the scope of protection of the present application.

It should be noted that the terms “first”, “second” and so forth, in the description and claims of the present application and in the above-described drawings, are used to distinguish between similar objects and not necessarily to describe a particular order or sequential order. It should be understood that the data so used may be interchanged where appropriate in order to facilitate the embodiments of the present application described herein. In addition, the terms “comprising”, “having”, and any variations thereof are intended to cover non-exclusive inclusions, for example, processes, methods, systems, products, or devices that contain a series of steps or units need not be limited to those explicitly listed steps or units, but may include other steps or units not explicitly listed or inherent to these processes, methods, products, or devices.

It should be noted that the embodiments of the present application and the features of the embodiments may be combined with each other without conflict. The present application will be described in detail below with reference to the accompanying drawings and in conjunction with embodiments.

According to one aspect of the present application, an embodiment of the present application provides a data model matching method, which is applied to an OLAP query system. FIG. 1 is a schematic flowchart of the data model matching method provided in the embodiment of the present application, and as shown in FIG. 1, the method includes the following steps 100 to 400:

100: determining at least two target data sets required to be queried by a query instruction and an ordered association between the target data sets.

Wherein the query instruction can be used for inputting an instruction for querying service by a user through a user side, the query instruction at least includes an instruction character sequence, for example, the query instruction is an SQL query instruction for SQL service, and the query instruction includes information of a plurality of target data sets and association information between the target data sets, such that an ordered association between the target data sets can be determined according to the association information, wherein the ordered association is an association mode with an association direction, for example, the ordered association at least includes a unidirectional association and/or a bidirectional association.

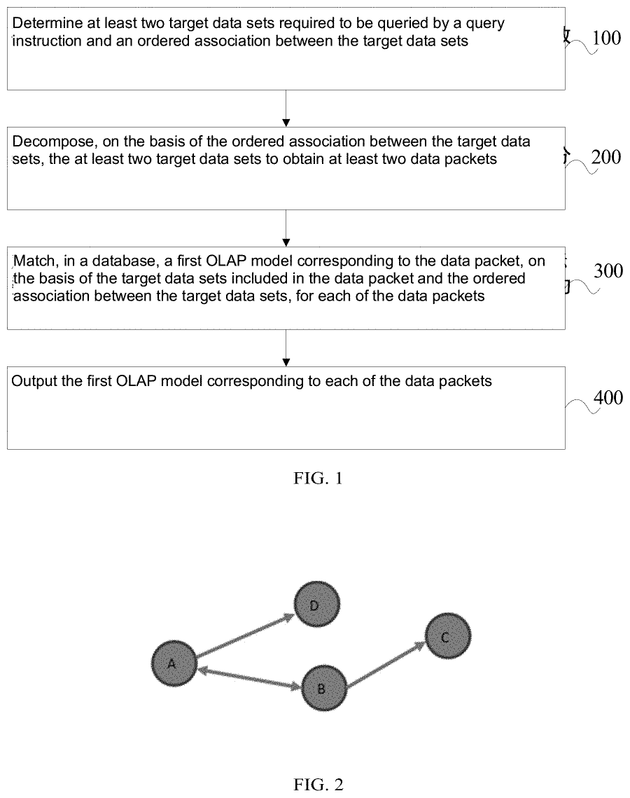

Illustratively, the query instruction is the SQL query instruction for the SQL service, the query instruction includes information of four target data sets A, B, C and D and the association information between the target data sets, the association information between A and B is INNER JOIN, the association information between A and D is LEFT JOIN, and the association information between B and C is LEFT JOIN, such that it can be determined that the ordered association between A and D is a unidirectional association of A to D, the ordered association between B and C is a unidirectional association of B to C, and the association information INNER JOIN between A and B belongs to an equivalent association, namely, “A INNER JOIN B” and “B INNER JOIN A” can be expressed in a unified manner, and the ordered association between the four target data sets A, B, C, and D is shown in FIG. 2.

It needs to be noted that in step 100, the number of target data sets required to be queried by the query instruction can be at least three, because when the target data set required by one query instruction is one or two target data sets containing the ordered association, the OLAP query system can easily match a unique global optimal OLAP model, and the possibility that no corresponding optimal OLAP model exists in the OLAP query system for three or more target data sets containing the ordered associations is relatively high.

200: decomposing, on the basis of the ordered association between the target data sets, the at least two target data sets to obtain at least two data packets, wherein each of the data packets includes at least one target data set.

Specifically, all corresponding target data sets (at least two target data sets) required by the query instruction are decomposed on the basis of the ordered association between the target data sets, so as to obtain at least two data packets, and each of the data packets includes at least one target data set; and due to the fact that decomposition is performed on the basis of the ordered association between the target data sets, when the number of the target data sets included in the data packet is two or more, the ordered association exists between the target data sets in the same data packet, due to the fact that the ordered association exists between the target data sets included in the two data packets of different data packets, the ordered association between the data packets is guaranteed, and meanwhile, it is guaranteed that the number of target data sets included in each of the data packets is smaller than all the corresponding target data sets required by the query instruction, such that it is guaranteed that each of the data packets matches the corresponding OLAP model more easily.

Illustratively, one query instruction requires four target data sets A, B, C and D, the ordered association as shown in FIG. 2 exists between the four target data sets A, B, C and D, the four target data sets A, B, C and D are decomposed on the basis of the ordered association between the four target data sets A, B, C and D to obtain two data packets, the first data packet includes A and D, the second data packet includes B and C, and the association between the two data packets is achieved by means of the bidirectional association between A and B. Moreover, the bidirectional association between A and B is also conducive to subsequent data processing between OLAP models, such that decomposition can be performed on the basis of the bidirectional association between the target data sets.

300: matching, in a database, a first OLAP model corresponding to the data packet, on the basis of the target data sets included in the data packet and the ordered association between the target data sets, for each of the data packets.

Specifically, for each of the data packets, the first OLAP model corresponding to the data packet is matched on the basis of the target data sets included in the data packet and the ordered association between the target data sets, and the specific process may include, for example, determining, on the basis of the target data sets included in the data packet, an OLAP model only including all the target data sets, and for each OLAP model only including the target data set included in the data packet, whether the target data sets included in the OLAP model conform to the ordered association between the target data sets included in the data packet is judged, and if yes, the OLAP model is output to serve as the first OLAP model corresponding to the data packet.

400: outputting the first OLAP model corresponding to each of the data packets.

Specifically, after each of the data packets matches the corresponding first OLAP model, the first OLAP model corresponding to each of the data packets is output. In this way, the success rate of OLAP model matching for the query instruction can be greatly improved, the support degree of OLAP model query matching is greatly improved, and then the analysis acceleration advantage brought by pre-calculation by means of the OLAP models is reserved for execution of the query instruction; and moreover, by means of the above-mentioned method, the application range of the OLAP data models is enlarged simultaneously, the demand quantity of OLAP models is reduced, the utilization rate of the OLAP models is improved, and the existing OLAP models are reused to the maximum extent.

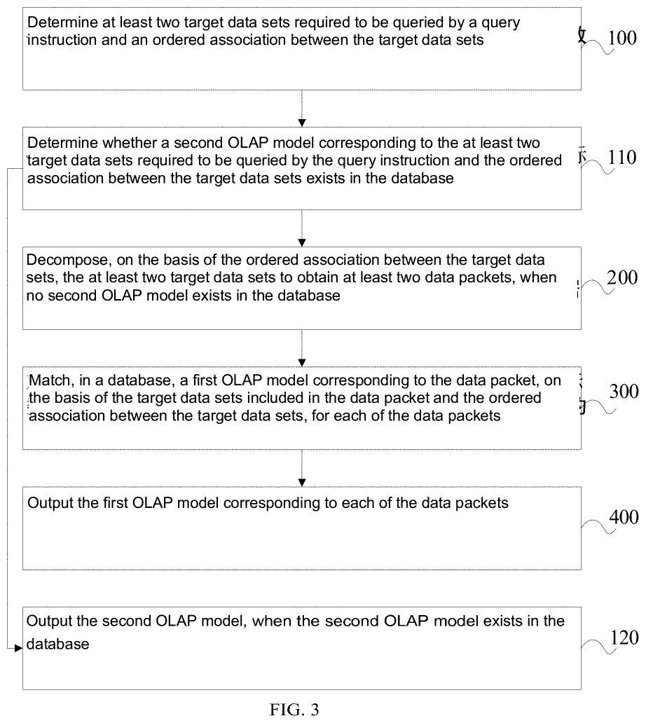

In a feasible implementation mode, FIG. 3 is a schematic flowchart of another data model matching method provided in an embodiment of the present application, and as shown in FIG. 3, after the step 100 of determining at least two target data sets required to be queried by the query instruction and the ordered association between the target data sets, the method further includes the following steps 110 and 120:

110: determining whether a second OLAP model corresponding to the at least two target data sets required to be queried by the query instruction and the ordered association between the target data sets exists in the database; and

Executing, when no second OLAP model corresponding to the at least two target data sets required to be queried by the query instruction and the ordered association between the target data sets exists in the database, the step 200 of decomposing, on the basis of the ordered association between the target data sets, the at least two target data sets; and

120: when the second OLAP model corresponding to the at least two target data sets required to be queried by the query instruction and the ordered association between the target data sets exists in the database, outputting the second OLAP model.

Specifically, after the at least two target data sets required to be queried by the query instruction and the ordered association between the target data sets are determined, whether the second OLAP model (wherein the second OLAP model is used as an optimal OLAP model) corresponding to all target data sets required to be queried by the query instruction and the ordered associations between the target data sets exists is matched in the database, when the second OLAP model exists in the database, the second OLAP model is directly output, when no second OLAP model exists in the database, step 200 of decomposing, on the basis of the ordered association between the target data sets, the at least two target data sets to obtain at least two data packets is executed, the first OLAP model (wherein the first OLAP model is used as a suboptimal OLAP model) corresponding to each of the data packets is obtained by means of step 300, and the first OLAP model corresponding to each of the data packets is output by means of the step 400.

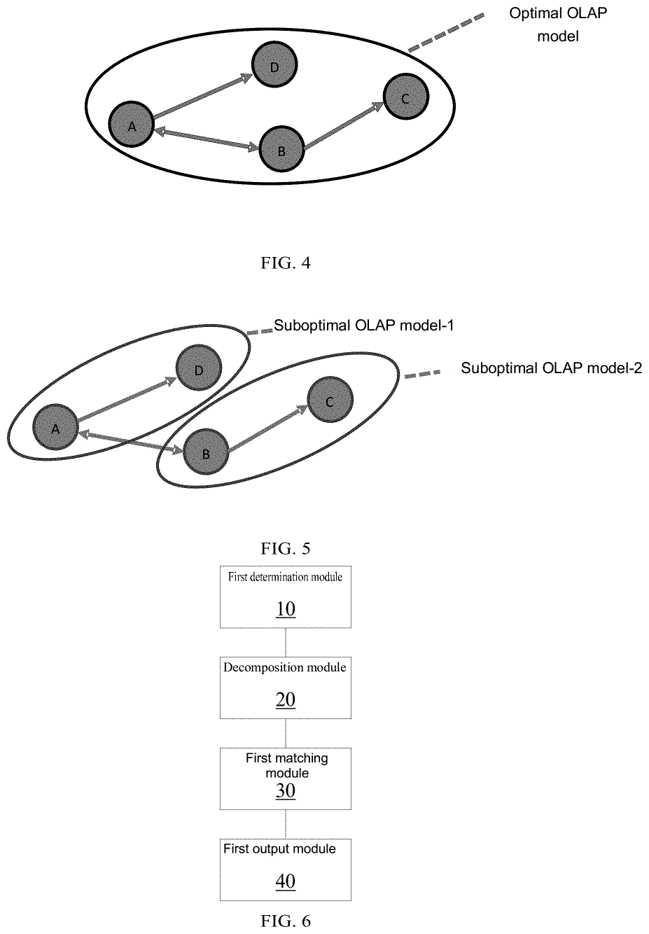

Illustratively, one query instruction requires four target data sets A, B, C, and D, there is an ordered association between the four target data sets A, B, C, and D as shown in FIG. 2, when the second OLAP model corresponding to the query instruction exists in the database, the second OLAP model is output as the optimal OLAP model, as shown in FIG. 4, when no second OLAP model exists in the database, by means of the step 200, the four target data sets A, B, C and D are decomposed on the basis of the ordered association between the four target data sets A, B, C and D to obtain two data packets, the first data packet includes A and D, the second data packet includes B and C, by means of the step 300, a first OLAP model corresponding to the first data packet comprising A and D is obtained as a suboptimal OLAP model-1, a first OLAP model corresponding to the second data packet comprising B and C is obtained as a suboptimal OLAP model-2, and as shown in a FIG. 5, by means of the step 400, the first OLAP model (suboptimal OLAP model-1) corresponding to the first data packet and the first OLAP model (suboptimal OLAP model-2) corresponding to the second data packet are output.

In a feasible implementation mode, the method further includes:

Taking, when only one target data set is included in the data packet, the only target data set included in the data packet as the first OLAP model corresponding to the data packet.

Specifically, when only one target data set is included in the data packet, the only target data set included in the data packet may be taken as the first OLAP model corresponding to the data packet, and the first OLAP model is output together with first OLAP models corresponding to other data packets.

In a feasible implementation mode, before the step 400 of outputting the first OLAP model corresponding to each of the data packets, the method further includes:

Determining whether a data packet which does not match a corresponding first OLAP model exists; and

Re-executing, when the data packet which does not match the corresponding first OLAP model exists, the step 200 of decomposing, on the basis of the ordered association between the target data sets, the at least two target data sets to obtain a data packet different from that in the previous decomposition.

Specifically, when the data packet which does not match the corresponding first OLAP model exists, it may be determined that the data packet cannot match the corresponding first OLAP model, therefore the step 200 needs to be re-executed to obtain the data packet different from that in the previous decomposition, it needs to be noted that when the step 200 is re-executed, the data packet which does not match the corresponding first OLAP model can be directly decomposed to obtain at least two data packets (the at least two data packets can be regarded as sub-packets of the data packet which does not match the corresponding first OLAP model), and then the step 300 continues to be executed to obtain first OLAP models corresponding to the two data packets separately, and those skilled in the art can re-decompose all corresponding target data sets (at least two target data sets) required by the query instruction.

According to the data model matching method provided by the present application, the at least two target data sets required to be queried by the query instruction and the ordered association between the target data sets are determined by means of the step 100; on the basis of the ordered association between the target data sets, the at least two target data sets are decomposed to obtain at least two data packets by means of the step 200, wherein each of the data packets include at least one target data set; for each of the data packets, on the basis of the target data set included in the data packet and the ordered association between the target data sets, the first OLAP model corresponding to the data packet is matched in a database by means of the step 300; and the first OLAP model corresponding to each of the data packets is output by means of the step 400. According to the above-mentioned method, the at least two target data sets required to be queried can be subjected to ordered association decomposition for the query instruction, OLAP model matching is performed on each of the data packets obtained by decomposition, and then a plurality of associated OLAP models corresponding to the query instruction are output, so that the success rate of OLAP model matching for the query instruction can be greatly improved, the support degree of OLAP model query matching can be greatly improved, and then the analysis acceleration advantage brought by pre-calculation by means of the OLAP models is reserved for execution of the query instruction; moreover, by means of the method, the application range of the OLAP data models is enlarged simultaneously, the demand quantity of OLAP models is reduced, the utilization rate of the OLAP models is improved, and the existing OLAP models are reused to the maximum extent; and therefore, the technical problems of large demand quantity of OLAP models included in the OLAP query system and a low utilization rate of the OLAP models in the related art are solved.

Based on the same technical concept, the present application further provides a data model matching device, which is applied to the OLAP query system. FIG. 6 is a schematic structural diagram of the data model matching device provided by an embodiment of the present application, and as shown in FIG. 6, the device includes:

A first determination module 10, configured to determine at least two target data sets required to be queried by a query instruction and an ordered association between the target data sets;

A decomposition module 20, configured to decompose, on the basis of the ordered association between the target data sets, the at least two target data sets to obtain at least two data packets, wherein each of the data packets includes at least one target data set;

A first matching module 30, configured to match, in a database, a first OLAP model corresponding to the data packet, on the basis of the target data set included in the data packet and the ordered association between the target data sets, for each of the data packets; and

A first output module 40, configured to output the first OLAP model corresponding to each of the data packets.

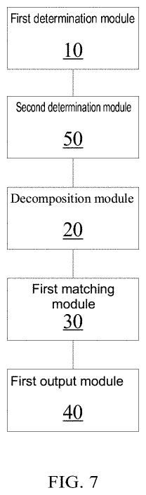

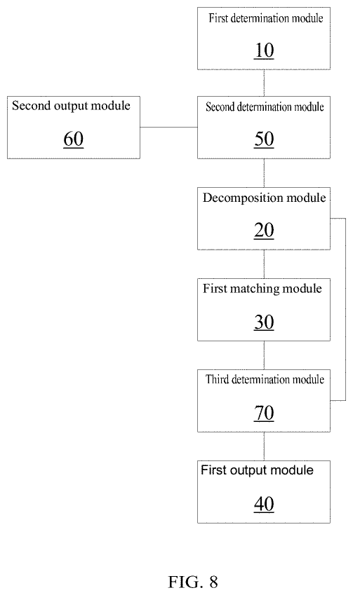

Optionally, FIG. 7 is a schematic structural diagram of another data model matching device provided in an embodiment of the present application, and as shown in FIG. 7, the device further includes a second determination module 50,

The second determination module 50 is configured to determine whether a second OLAP model corresponding to the at least two target data sets required to be queried by the query instruction and the ordered association between the target data sets exists in the database; and

A decomposition module 20 is configured to execute, when no second OLAP model corresponding to the at least two target data sets required to be queried by the query instruction and the ordered association between the target data sets exists in the database, the step of decomposing, on the basis of the ordered association between the target data sets, the at least two target data sets.

Optionally, FIG. 8 is a schematic structural diagram of another data model matching device provided in an embodiment of the present application, and as shown in FIG. 8, the device further includes a second output module 60 and a third determination module 70:

The second output module 60 is configured to output, when the second OLAP model corresponding to the at least two target data sets required to be queried by the query instruction and the ordered association between the target data sets exists in the database, the second OLAP model;

The third determination module 70 is configured to determine whether the data packet which does not match the corresponding first OLAP model exists; and

The decomposition module 20 is configured to re-decompose, on the basis of the ordered association between the target data sets, the at least two target data sets to obtain the data packet different from that in the previous decomposition when the data packet which does not match the corresponding first OLAP model exists.

Optionally, the device further includes:

A setting module, configured to take, when only one target data set is included in the data packet, the only target data set included in the data packet as the first OLAP model corresponding to the data packet.

According to the data model matching device provided by the present application, the first determination module 10 is configured to determine at least two target data sets required to be queried by a query instruction and ordered association between the target data sets; the decomposition module 20 is configured to decompose, on the basis of the ordered association between the target data sets, the at least two target data sets to obtain at least two data packets, wherein each of the data packets includes at least one target data set; the first matching module 30 is configured to match, on the basis of the target data set included in the data packet and the ordered association between the target data sets, the first OLAP model corresponding to the data packet from the database for each of the data packets; and the first output module 40 is configured to output the first OLAP model corresponding to each of the data packets. In this way, the at least two target data sets needing to be queried can be subjected to ordered association decomposition for the query instruction, OLAP model matching is performed on each of the data packets obtained by decomposition, and then the plurality of associated OLAP models corresponding to the query instruction are output, so that the success rate of OLAP model matching for the query instruction can be greatly improved, the support degree of OLAP model query matching can be greatly improved, and the analysis acceleration advantage brought by pre-calculation by means of the OLAP models is reserved for execution of the query instruction; moreover, by means of the method, the application range of the OLAP data models is enlarged simultaneously, the demand quantity of OLAP models is reduced, the utilization rate of the OLAP models is improved, and the existing OLAP models are reused to the maximum extent; and therefore, the technical problems of large demand quantity of OLAP models included in the OLAP query system and a low utilization rate of the OLAP models in the related art are solved.

Based on the same technical concept, an embodiment of the present application further provides a computer device, which includes:

One or more processors; and

A memory, configured to store one or more computer programs;

The one or more computer programs, when executed by the one or more processors, cause the one or more processors to implement the data model matching method mentioned above.

Based on the same technical concept, an embodiment of the present application further provides a computer-readable storage medium, having computer codes stored thereon, and the computer codes, when executed, cause the data model matching method to be performed.

Obviously, those skilled in the art should appreciate that the modules or steps of the present invention mentioned above may be implemented with a general-purpose computation device, and may be centralized on a single computation device or distributed on a network composed of a plurality of computation devices, Optionally, they may be implemented with program codes executable by the computation device, such that the they may be stored in a storage device to be executed by the computation device, or they may be fabricated separately as individual integrated circuit modules, or multiple modules or steps of them may be fabricated as a single integrated circuit module for implementation. Thus, the invention is not limited to any particular combination of hardware and software.

The computer programs involved in the present application may be stored in the computer-readable storage medium, which may include: any physical device, virtual device, USB flash disk, removable hard disk, magnetic disk, optical disk, computer memory, read-only computer memory (ROM), random access memory (RAM), electrical carrier signal, and telecommunication signal, and other software distribution media capable of carrying the computer program codes.

Obviously, those skilled in the art should appreciate that the modules or steps of the present invention mentioned above may be implemented with a general-purpose computation device, and may be centralized on a single computation device or distributed on a network composed of a plurality of computation devices, Optionally, they may be implemented with program codes executable by the computation device, such that the they may be stored in a storage device to be executed by the computation device, or they may be fabricated separately as individual integrated circuit modules, or multiple modules or steps of them may be fabricated as a single integrated circuit module for implementation. Thus, the invention is not limited to any particular combination of hardware and software.

The foregoing is merely illustrative of the preferred embodiments of the present application and is not intended to limit the present application, and various changes and modifications may be made on the present application by those skilled in the art. Any modifications, equivalent substitutions, improvements, and the like within the spirit and principles of the present application should all fall within the scope of protection of the present application.

What is claimed is:

1. A data model matching method, applied to an online analytical processing (OLAP) query system, the method comprising:
determining at least two target data sets required to be queried by a query instruction and an ordered association between the target data sets;
decomposing, on the basis of the ordered association between the target data sets, the at least two target data sets to obtain at least two data packets, wherein each of the data packets includes at least one target data set;
matching, in a database, a first OLAP model corresponding to the data packet, based on the target data sets included in the data packet and the ordered association between the target data sets, for each of the data packets; and
outputting the first OLAP model corresponding to each of the data packets.

2. The data model matching method according to claim 1, wherein after the determining at least two target data sets required to be queried by the query instruction and the ordered association between the target data sets, the method further comprises:
determining whether a second OLAP model corresponding to the at least two target data sets required to be queried by the query instruction and the ordered association between the target data sets exists in the database; and
executing, when no second OLAP model corresponding to the at least two target data sets required to be queried by the query instruction and the ordered association between the target data sets exists in the database, the step of decomposing, on the basis of the ordered association between the target data sets, the at least two target data sets.

3. The data model matching method according to claim 2, wherein the method further comprises:
outputting the second OLAP model, when the second OLAP model corresponding to the at least two target data sets required to be queried by the query instruction and the ordered association between the target data sets exists in the database.

4. The data model matching method according to claim 1, wherein the method further comprises:
taking, when only one target data set is included in the data packet, the only target data set included in the data packet as the first OLAP model corresponding to the data packet.

5. The data model matching method according to claim 4, wherein before the outputting first OLAP model corresponding to each of the data packets, the method further comprises:
determining whether a data packet that does not match a corresponding first OLAP model exists; and
re-executing, when the data packet that does not match the corresponding first OLAP model exists, the step of decomposing, on the basis of the ordered association between the target data sets, the at least two target data sets to obtain a data packet different from that in a previous decomposition.

6. A data model matching device, applied to an OLAP query system, the device comprising:
a first determination module, configured to determine at least two target data sets required to be queried by a query instruction and an ordered association between the target data sets;
a decomposition module, configured to decompose, on the basis of the ordered association between the target data sets, the at least two target data sets to obtain at least two data packets, wherein each of the data packets includes at least one target data set;
a first matching module, configured to match, in a database, a first OLAP model corresponding to the data packet, based on the target data set included in the data packet and the ordered association between the target data sets, for each of the data packets; and
a first output module, configured to output the first OLAP model corresponding to each of the data packets.

7. The data model matching device according to claim 6, the device further comprising a second determination module, wherein
the second determination module is configured to determine whether a second OLAP model corresponding to the at least two target data sets required to be queried by the query instruction and the ordered association between the target data sets exists in the database; and
the decomposition module is configured to execute, when no second OLAP model corresponding to the at least two target data sets required to be queried by the query instruction and the ordered association between the target data sets exists in the database, the step of decomposing, on the basis of the ordered association between the target data sets, the at least two target data sets.

8. The data model matching device according to claim 6, wherein the device further comprises:
a setting module, configured to take, when only one target data set is included in the data packet, the only target data set included in the data packet as the first OLAP model corresponding to the data packet.

9. A computer device, comprising:
one or more processors; and
a memory, configured to store one or more computer programs;
the one or more computer programs, when executed by the one or more processors, causing the one or more processors to implement the data model matching method of any one of claims 1-5.

10. A computer-readable storage medium, having computer codes stored thereon, the computer codes, when executed, causing the data model matching method of any one of claims 1-5 to be performed.
